(19) United States
(12) Patent Application Publication
(10) Pub. No.: US 2002/0082903 A1
(43) Pub. Date: Jun. 27, 2002

(54) Real estate net-market system

(76) Inventor: Seiichiro Yasuzawa, Kawasaki-shi (JP)

Correspondence Address: ROSENMAN & COLIN LLP, 575 MADISON AVENUE, NEW YORK, NY, 10022-2585, US

(21) Appl. No.: 09/887,514

(22) Filed: Dec. 7, 2001

(30) Foreign Application Priority Data
Jun. 22, 2000 (JP) 2000-188699

(51) Int. Cl. G06F 17/60

(52) U.S. Cl. 705/10

(57) ABSTRACT

A real estate network market system comprises the calculation of a reasonable price range and yield, which are presented to a seller and a prospective buyer. In the event that the maximum desired buying price presented by the buyer is lower than the desired selling price, and the difference is higher than an adjustment rate, both parties shall revise their prices until the desired selling price and the maximum desired buying price are in equilibrium. If the difference is within the adjustment rate, the average of the desired selling price and the maximum buying price is presented to the seller and the prospective buyer who presented the maximum desired buying price, and thereby adjusted by the market company. A virtual building is created on a network, the market data is integrated, the equilibrium price is determined, and an index pertaining to investment real estate is produced.

### FIELD OF THE INVENTION

This invention relates to e.g. real estate transaction business, particularly market system of real estate transactions such as buying and selling for the real estate for investment.

### DESCRIPTION OF THE PRIOR ART

The Internet made it possible to connect the information of various products and service to the individual and the company, and get delivery cost inexpensive. As a result, the environment of the individual life has been dramatically changed and any business cannot stands up without the Internet.

The real estate business, also has been entering upon a new era by appearance of real estate investment trust (REIT).

However, as for the buying and selling of real estate, although we can use the system of the auction or bid of the broker and get the real estate information from the magazine, we don't have the system which connect a seller and a purchaser directly.

The innovating of information routes and the cost down of delivery by the Internet are strongly required at present, but it seems difficult that we have the system to connect directly seller and purchaser even in the future for real estate transaction.

Because of the following reason, the real estate market is incomplete and agency business of the real estate is required at the market.

Unlike the general product, the defect in real estate is hidden.

Price of the real estate isn't obvious while not evaluating.

The total value of one real estate is big.

The contract of conditions of the real estate is complicated.

The role of the broker in case of real estate transaction is surely big. When they receive a request from the seller, they inspect the object real estate, they do price setting while discussing with the seller, look for a buyer and negotiate with them so that the seller and buyer get agreed in the buying and selling based on the setting price. When it isn't possible to agree, they persuade seller to lower the price or they search the new buyer.

They repeat the same process and spend time and cause to reach the agreement as a result of negotiation many times.

When spends long time in this way, the seller and the purchaser must pay 3% broker Fee of the contract price as the agency fee in case of the contract being finalized. 3% Fee is very high for the seller and the purchaser, but in existing system, the competition doesn't work and 3% rules are maintained as broker fee.

With the reconsideration of the collapse of the bubble economy, the real estate securitization centering on the commercial real estate turned into full swing from 1999. Real Estate Investment Trust will be listed on the Tokyo Stock Exchange in 2001, getting finance through the bond and equity, composing several real estate properties and being invested by the individual who like the higher return product than the conventional investment products.

However, when the investor want to sells the real estate investment trust because of the rise of the interest rate or because of the sagging of the real estate price, therefore, the real estate portfolio management strategy company tries to sell the real estate property which composes real estate investment trust with the situation to sell, it is difficult to sell immediately and moreover efficiently in the present real estate trading system.

Liquidity of the stocks of real estate turned the securities were secured in being listed, however the liquidity of real estate itself was not improved. The real estate trading system to sell the real estate immediately and moreover efficiently is necessary for the stability of the real estate investment trust market.

Also, as for real estate, the price of the object real estate isn't Obvious or fixed, because the value of it is different one by one and there isn't a rational market for the real estate like the merchandise products and the stock.

Therefore, in case of buying and selling, the seller fixes the price of the object real estate first but as long as the price can't be seen like the purchasing production cost and the stock price, he can not fix a sales price easily.

Even if the price by the self valuation of seller himself is firstly made generally, the seller decides sales price by referring the price which the broker evaluated or in case of more theoretical and fair price's being necessary, he gets real estate appraisal evaluation by a real estate appraiser.

A way of conventional appraisal evaluation to fix the price was shown in FIG. 5.

Firstly the appraiser seeks an integrating price by the Cost Method and a income price by Capitalized Income Approach to Value, and he adjusts two prices, and estimates the final adjusted price of the object real estate.(regard to the land price, it was sought by the Sale Comparison Method)

As for capitalized income approach to value, there are two cases, DCF Method (Discounted Cash Flow Method) mentioned in the following and Capitalized Earnings Method.

However, the appraisal price is “the proper price showing the market price which will be formed in the rational market about the real estate which having a market” (The report about the setting of a real estate appraisal evaluation standard), but it is not a market balance price.

The market balance price is the estimated amount for which property information should be exchange enough between a willing buyer and willing seller in an arm's-length, prudently, and without compulsion”. (Under the IVSC standards, Market Value is defined as)

Therefore, a market balance price is the price to be reasonably formed between seller and buyer.

However, it is sometimes misunderstood that the price appraised by the appraiser is the market balance price which was made by “the invisible hand of God ”. The illusion makes seller try to sell at the price higher than the appraisal price by the appraiser and makes the buyer wants to buy at the price lower than it.

The illusion makes a psychological wall between seller and buyer with the price and it obstructs smooth buying and selling as the result.

Moreover, to seek the one fixed price like the market balance price lower the accuracy of the appraisal price.

For example, when the appraiser makes the application of DCF, firstly he estimates a discount rate, a terminal rate, the rental growth rate of future, and he decides the income price by a cash flow of future which was sought by estimating these items.

However it is difficult for him to estimate the variable items because the value changes, he must fix one value in one item.

Risk and return are fixed by the income price which was sought in this way.

For example, as the DCF method is shown in “Real Estate Income Approach Value and Investment Analysis” (written by Tsukamoto Isao, published by Seibunsha, page 92) or “A guide to yield at the real estate” (written by Okuda Katue, published by Jyutaku-shinpou-shiya, page 54)”.

The income price by the DCF method is sought by totaling the present value of the income which is gotten during the holding period at the object real estate and the capital which is gotten at the sale after the holding period .

In case of evaluation, (the appraiser) seeks a income approach price By DCF first after estimating one figure per every variable items such as the office fare fee, the management expenses, the discount rate and so on. The income approach price by DCF is the price that is found from actual cash flow and suitable for an investment judgment. However, accuracy of income approach price is limited because the Range of variable items to be estimated is very wide.

However, on the occasion of buying and selling of an actual real estate for the investment, even if the investors make investment analysis with DCF, each investor get different price for investment because the estimate of theses variable items is different among investors.

It is natural that each investors has different opinion on the price.

By utilizing the different estimation, appraiser must seek a certain range of income approaching prices which is led by choosing every possible proper value for variable items. In this way, it is more reasonable to choose one price among the range of income approach prices by DCF as the purchase price for investors. The investor chooses estimate value of each variable items as a result.

The matrix evaluation means seeking more than one income approach prices by the way of inputting the values after estimating the range of proper values of each variable items.

As mentioned above, the real estate for the investment becomes a financial product by the securitization of the real estate.

Individual is being able to invest small amount of real estate by REIT to be listed in Tokyo Stock Exchanges.

For the purpose, the benchmark is required when investors makes investment judgment. Benchmark in real estate investment is Real Estate Index that shows a return of the investment including income and capital gain.

More accurate real estate index will become benchmark for cap rate (residual cape rate) and discount rate (to get present value) and will play a big role for Current Value Accounting Standard which will be started in Japan within a few years as result of globalization of accounting standard.

However, as for the real estate index for the investment, there are no authorized one although someone try to make it.

The reason why it is difficult for the real estate index to be made in Japan is as follows.

Because the investors and owners do not want to disclose dealing price, leasing conditions, property information and so on, it is very difficult to get necessary information for Real Estate Index in Japan.

The corpus price of the index can not be sought at the income approach price. In Japan, evaluation of the land and the building is executed separately.

About appraisal of Office Property, appraiser gets the price of the land using public indicated price or comparison method and get the price of Building price by cost approach method.

As for existing index, too, the denominator becomes the corpus price which was completely sought by this way. This point is big problem.

Because, on the occasion of actual dealings, the investor analyzes return and make investment by the price based on the return.

The appraiser who make real estate index seeks the separate evaluation of the land and the building, Real Estate Index can not be helpful for actual dealing.

However, there is contradiction that Appraiser who make Real Estate Index needs appropriate cap rate and discount rate.

This invention is that by integrating Real Estate evaluation into market function, Buyer and Seller can exchange directly real estate information on the screen of the Internet and can fix purchase and sales price.

This system makes the efficiency of the buying and selling dealings of the real estate improved, makes an agency fee down and makes the process of the buying and selling price decision transparency.

### SUMMARY OF THE INVENTION

To Improve the efficiency of the buying and selling dealings in fixing a buying and selling price by way of seller and the purchaser' exchanging information directly on the net screen.

To make an agency fee down and makes the process of the price decision transparency.

To give the accurate index of the real estate investment which reflect immediately the charge of Interest rate and market rate of the rent.

### BRIEF DESCRIPTION OF THE DRAWING

FIG. 1 is the system figure that shows the implementation example of this invention.

FIG. 2 is the flow figure that shows exchanging information of the net market.

FIG. 3 is the flow figure that shows the process of the price forming of the net market.

FIG. 4 is the block diagram that shows the decision of the reasonable price range.

FIG. 5 is the block diagram that shows the decision of the conventional appraisal.

FIG. 6 is the diagram that shows the example of the way of calculating a conventional index.

FIG. 7 is the graph that shows a range price example.

### DESCRIPTION OF THE PREFERRED EMBODIMENT

The real estate network market system constituting this invention is comprised of the following steps:

(1) An investor is registered as a member.

(2) A seller presents an outline of the subject matter to the Market Company. In these specifications, the Market Company means a party who executes business transactions or acts relating to same, such as due diligence (carefully conducted research and analysis), matrix appraisals, information transfers between seller and buyer, and preparation of agreements.

(3) The Market Company presents a reasonable price range to seller by executing an analysis of the business outline pertaining to the subject matter and due diligence with respect to the subject matter, employing a real estate appraisal assessment method, and calculating a reasonable price range based on a matrix appraisal.

Among real estate appraisal assessment methods, the DCF method and others involve many anticipation variables for trial calculations. Consequently, a reasonable price range is established under this invention by undertaking an assessment by use of the DCF method upon determining a reasonable range for each variable, and incorporating prices calculated by other methods.

The DCF method is the easiest for arriving at trial calculations of a price range, but it is possible to obtain a rational price range by other methods; such as the development method, which calculates the price of land for apartment housing construction or land for sale by deducting construction and other costs and invested capital from the selling price; or the business case comparison method, which calculates the price of the subject real estate by comparing pricing factors derived from business cases. Such methods are included in the matrix evaluation (or assessment) in these specifications.

(4) Seller presents a desired selling price falling within the reasonable price range to the Market Company; or Seller gives approval to the reasonable price range and seller can present a desired selling price falling within the reasonable price range to the Market Company at a point in time to fall no later than step (10).

(5) The Market Company discloses an outline of the subject matter and the reasonable price range to members.

(6) A requesting member is registered by the Market Company as a prospective buyer of the subject matter in question.

(7) The Market Company presents a business outline of the subject matter, the results of executing due diligence, and the matrix evaluation (assessment) of the subject matter to the prospective buyer and determines the adjustment rate.

The adjustment rate is set at a level to enable coverage of the difference between the desired selling price and the desired buying price and can be presented to the seller and prospective buyer beforehand.

(8) The prospective buyer presents a desired buying price falling within the reasonable price range to the Market Company.

(9) In the event that the maximum desired buying price is lower than the desired selling price and the difference is higher than the adjustment rate, the seller shall revise the desired selling price and present it again to the Market Company. In addition, each prospective buyer shall revise their desired buying price and present it again to the Market Company until the desired selling price and the maximum desired buying price are in equilibrium within the adjustment rate.

(10) In the event that the maximum desired buying price is higher than the desired selling price, the average of the desired selling price and the maximum desired buying price is presented to the seller and the prospective buyer who presented the maximum desired buying price. In the event that the maximum desired buying price is lower than the desired selling price and the difference is within the adjustment rate, the average of the desired selling price and the maximum desired buying price is presented for adjustment to the seller and the prospective buyer who presented the maximum desired buying price.

The network market system constituting this invention is comprised of no less than the following steps:

(1) The Market Company calculates a reasonable price range and presents it to the seller and prospective buyer.

(2) The seller presents a desired selling price falling within the reasonable price range to the Market Company.

(3) The prospective buyer presents a desired buying price falling within the reasonable price range to the Market Company.

(4) In the event that the maximum desired buying price is lower than the desired selling price and the difference is higher than the adjustment rate, the seller shall revise the desired selling price and present it again to the Market Company. In addition, each prospective buyer shall revise their desired buying price and present it again to the Market Company until the desired selling price and the maximum desired buying price are in equilibrium within the adjustment rate.

(5) In the event that the maximum desired buying price is higher than the desired selling price, the average of the desired selling price and the maximum desired buying price is presented to the seller and the prospective buyer who presented the maximum desired buying price. In the event that the maximum desired buying price is lower than the desired selling price and the difference is within the adjustment rate, the average of the desired selling price and the maximum desired buying price is presented for adjustment to the seller and the prospective buyer who presented the maximum desired buying price.

The Market Company implements the above steps by use of a server connecting the real estate network market system constituting this invention with a network. Such a real estate network market system is a real estate network market system which can be accessed by registered members via the network and which can also be accessed by voluntary sellers via the network. To render the above steps feasible, the following measures are to be taken.

The first step involves measures pertaining to the inputting of an outline of the subject matter by the seller, measures pertaining to the calculation performed by the server of a reasonable price range in accordance with the matrix evaluation (assessment) and presentation thereof to the seller, and measures pertaining to the presentation by the seller of a desired selling price (or measures pertaining to the approval of a reasonable price range by the seller).

The second step involves measures pertaining to the disclosure of the outline of the subject matter and the reasonable price range by the server to members, measures pertaining to the registration of a desiring member in the server as a prospective buyer of such subject matter, and measures pertaining to the presentation of a desired buying price by the prospective buyer to the server.

The third step involves measures to take effect in the event that the maximum desired buying price is lower than the desired selling price and the difference is higher than the adjustment rate. This step dictates the measures by which the seller shall revise the desired selling price and present it again to the server, and by which each prospective buyer shall revise their desired buying price and present it again to the server until the desired selling price and the maximum desired buying price are in equilibrium within the adjustment rate.

The fourth step involves measures to take effect in the event that the maximum desired buying price is higher than the desired selling price, or in the event that the maximum desired buying price is lower than the desired selling price and the difference is within the adjustment rate. This step dictates the measures by which the average of the desired selling price and the maximum desired buying price is presented by the server to the seller and the prospective buyer who presented the maximum desired buying price.

In the alternative, no less than the follow measures shall be taken: measures pertaining to the calculation of a reasonable price range in accordance with the matrix evaluation (assessment) and presentation thereof, measures pertaining to the presentation of a desired buying price by the prospective buyer, and measures by which, in the event that the maximum desired buying price is higher than the desired selling price or in the event that the maximum desired buying price is lower than the desired selling price and the difference is within the adjustment rate, the average of the desired selling price and the maximum desired buying price is presented by the server to the seller and the prospective buyer who presented the maximum desired buying price.

A reasonable price range calculated in accordance with the aforesaid matrix evaluation (assessment) can be either a range inclusive of a range obtained by multiple pricing methods or a range overlapping two or more ranges obtained by multiple pricing methods.

In other models, the real estate network market system constituting this invention is comprised of the following steps:

(1) An investor is registered as a member.

(2) A seller presents an outline of the subject matter to the Market Company.

(3) In order to present a reasonable price range and yield as referred to hereunder, the Market Company executes an analysis of the business outline pertaining to the subject matter and due diligence with respect to the subject matter; employs a real estate appraisal assessment method; calculates a reasonable price range based on a matrix assessment; and calculates the yields pertaining to gross profit amounts corresponding to two or more prices which shall minimally include the upper and lower limits within the reasonable price range in question, with such prices constituting the principal amounts.

Within the reasonable price range in question, it is desirable that yields pertaining to gross profit values corresponding to given prices (market yields) relative to regularly fixed prices be presented together with the contents of assessment as evidence of the given prices.

(4) The seller proposes a desired selling price within the reasonable price range to the Market Company.

(5) The Market Company discloses the outline of the subject matter, the reasonable price range, and the aforesaid yields to members.

(6) A desiring member is registered by the Market Company as a prospective buyer of such subject matter.

(7) The Market Company presents a business outline, the results of executing due diligence, and the matrix evaluation (assessment) to the prospective buyer and determines the adjustment rate.

(8) The prospective buyer presents a desired buying price falling within the reasonable price range to the Market Company.

(9) In the event that the maximum desired buying price is lower than the desired selling price and the difference is higher than the adjustment rate, the seller shall revise the desired selling price and present it again to the Market Company. In addition, each prospective buyer shall revise their desired buying price and present it again to the Market Company until the desired selling price and the maximum desired buying price are in equilibrium within the adjustment rate.

(10) In the event that the maximum desired buying price is higher than the desired selling price, the average of the desired selling price and the maximum desired buying price is presented to the seller and the prospective buyer who presented the maximum desired buying price. In the event that the maximum desired buying price is lower than the desired selling price and the difference is within the adjustment rate, the average of the desired selling price and the maximum desired buying price is presented for adjustment to the seller and the prospective buyer who presented the maximum desired buying price.

It is desirable that the aforesaid matrix evaluation (assessment) includes the DCF method, and that the aforesaid yield is presented together with the deduction rate used by the DCF method, the terminal rate, and one or more yields selected from a set consisting of yields calculated from profitable prices obtained by the DCF method (called IRR or internal rate of return).

It is further desirable that the Market Company selects multiple buyers from among investors, creates a virtual subject matter, executes each and every step of the real estate network market system for such virtual subject matter, and discloses a reasonable price range pertaining to such virtual subject matter, yields pertaining to given prices relative to regularly fixed prices within the reasonable price range, and a yield pertaining to the aforesaid net profit value based on a principal price equivalent to the buyer's maximum desired buying price after adjustment by the statistical method or multiple desired buying prices after adjustment by the statistical method (this yield is referred to as market yield or real estate index) together with the outline pertaining to such subject matter.

Alternatively, it is desirable that the Market Company selects a single seller and multiple buyers from among investors; executes each and every step of the real estate network market system for multiple virtual subject matters as created by the Market Company; and discloses a reasonable price range pertaining to such virtual subject matters, yields pertaining to given prices relative to regularly fixed prices within the reasonable price range, and a yield pertaining to the aforesaid net profit value based on a principal price equivalent to the buyer's maximum desired buying price after adjustment by the statistical method or multiple desired buying prices after adjustment by the statistical method (this yield is referred to as market yield or real estate index) together with the outline pertaining to such subject matters.

The aforesaid network market system can be executed for purposes of buying and selling corporations, stocks, claims, intellectual property rights, art objects, antiques, or used articles, or for purposes of rendering services. The real estate index constituting a part of this invention is a system that employs matrix appraisals for regional virtual building groups created by the appraiser, reflects in the above network market the range price obtained for the virtual building, and instantly calculates a yield to fall between either the buyer's desired buying price, as determined through the pricing process of the network market, or the standard desired buying price, as calculated by the statistical method, and the currently assumed net profit value.

Because it is very difficult in Japan to collect data on matters such as contracted tenant rents pertaining to existing real estate properties for lease, trial calculations treat data on matters such as standard rents, vacancy rates, and standard maintenance costs in the targeted area market as an input item of the virtual building income price.

Furthermore, notwithstanding the fact that no existing real estate index conducts trial calculations of the principal price on the basis of an income price, it is possible to produce a real estate index that applies an equilibrium price (income price) and a gross profit value based on a system in which multiple income prices are calculated by the DCF method and multiple investors select prices from within an established reasonable price range.

The yield pertains to the virtual building, but it is possible to conduct a trial calculation of an income price to link with market data, such as a daily fluctuating interest rate as well as rent, and to continuously express investment assessments for prices and yields selected by multiple investors.

It is also possible to improve the accuracy of the appraisals by reflecting such yields in the matrix appraisals of actual real estate.

The network market system constituting this invention is a system by which real estate or equity in real estate is appraised by the Market Company operating as a neutral third party, a reasonable price is obtained in terms of a range, a seller and buyer are connected via the network, and a trade price is determined within the range price.

### EXAMPLES OF THE INVENTION

An embodiment of this invention is explained below in accordance with figures.

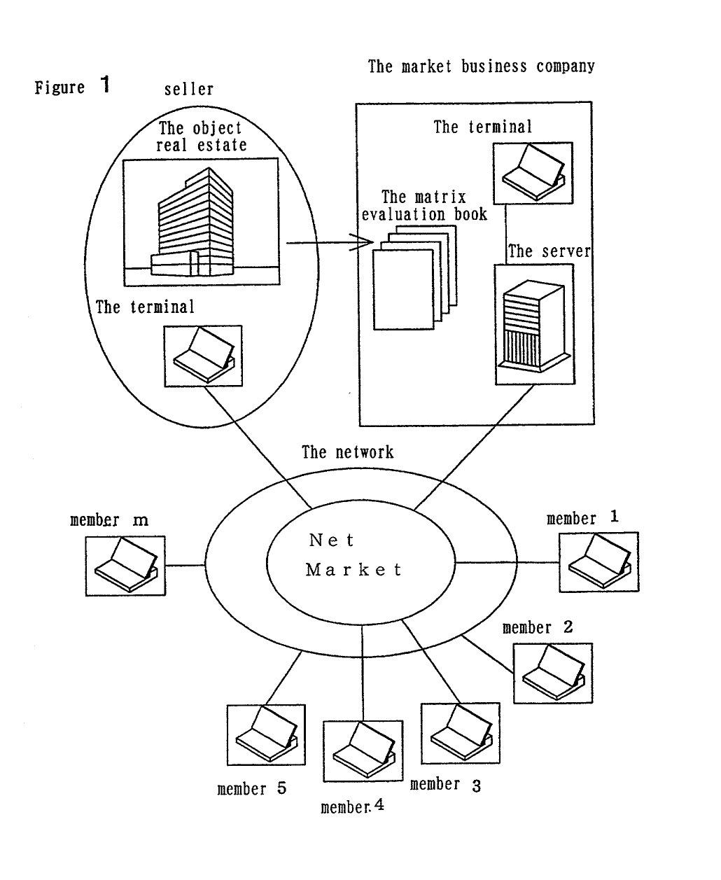

FIG. 1 is a system diagram depicting an embodiment of this invention.

The real estate network market system constituting this invention is a network market constructed by the Market Company on top of the existing network. Any existing server on which the network market software operates is available if it possesses the capacity to implement the measures that comprise this invention. Thee seller and members present and obtain information using their own compatible terminals (example: personal computers) to access this network.

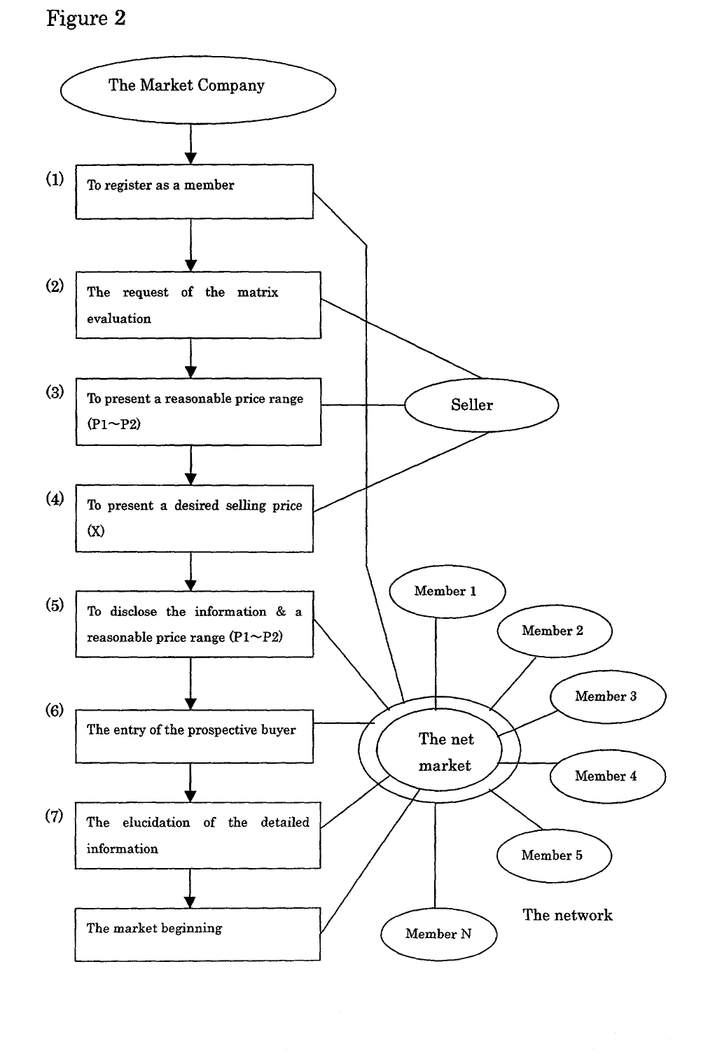

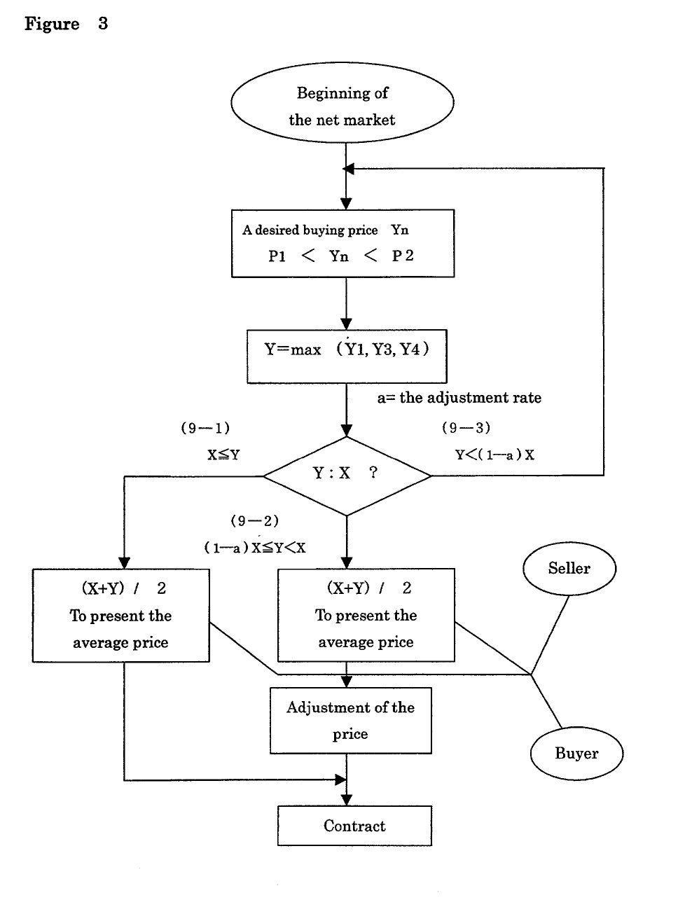

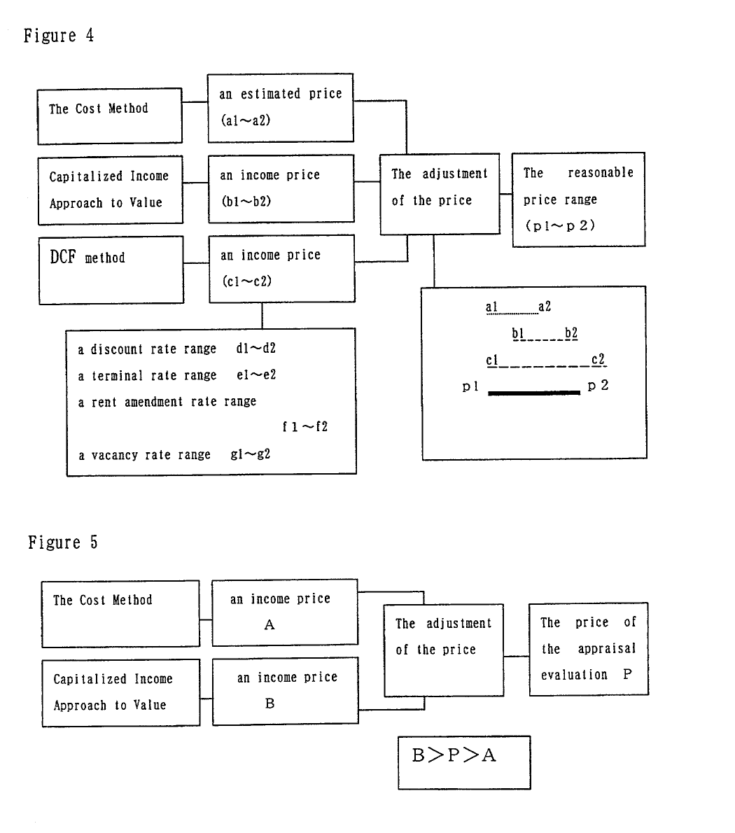

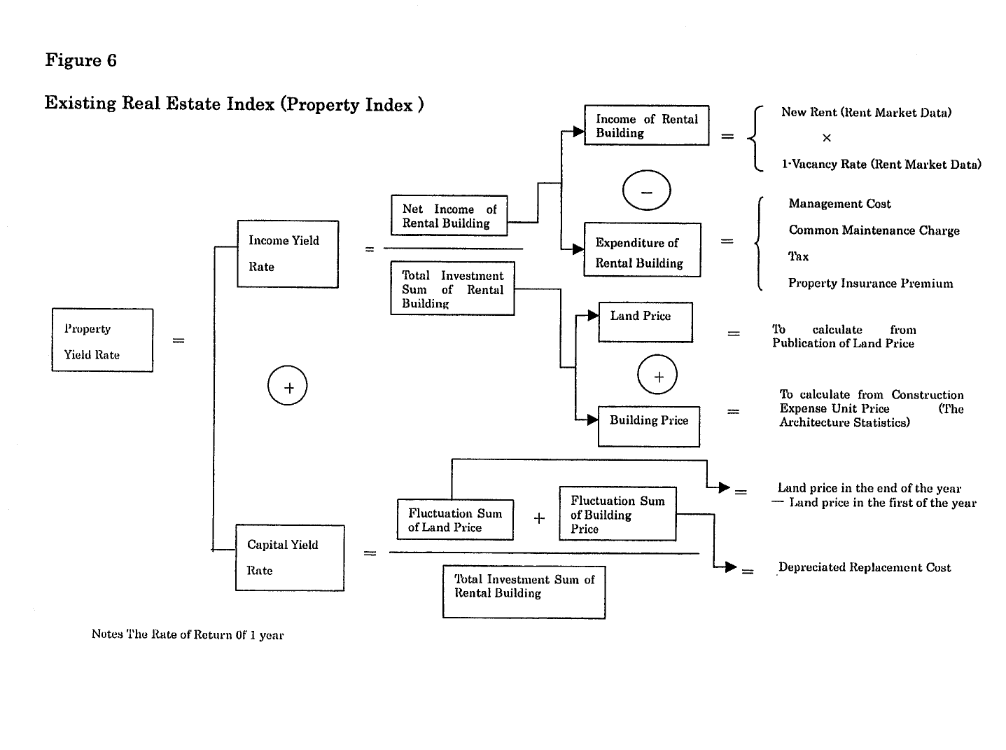

The steps up to and including the execution of contracts are explained below in accordance with the flow chart as shown in FIGS. 2 and 3.

(1) The investor is registered as a member through his own terminal. In the flow chart, members are indicated as member 1, 2, 3, 4, 5, and m.

It is not essential for this invention to adopt membership, but the registration of members in advance will enable the prompt engagement of individual transactions.

(2) The seller presents an outline pertaining to the subject matter to the Market Company and requests performance of an appraisal.

The outline pertaining to the subject matter includes, for example, location, surface area, construction, and terms and conditions for lease.

(3) The Market Company presents a reasonable price range to the seller by executing an analysis of the business outline pertaining to the subject matter and due diligence (carefully conducted research and analysis) with respect to the subject matter, employing a real estate appraisal evaluation (assessment) method, and calculating a reasonable price range (P1˜P2) based on a matrix appraisal. The Market Company inputs the outline pertaining to the subject matter and the reasonable price range (P1˜P2) into the server in order to store the data.

In order to present information pertaining to the subject matter to prospective buyers in the steps hereunder, it is important to execute the carefully conducted research and analysis (due diligence) with respect to the subject matter and it is necessary to include the results in the reasonable price range (P1˜P2).

The said due diligence includes examination of the physical property that comprises the real estate in question, title, and any other information and risk factor required and necessary in the process of buying and selling. For buildings (such as offices), an engineering report covering the LCC (life cycle cost) and risk assessment for earthquakes is prepared, and matrix appraisals are executed based on the real estate appraisal evaluation (assessment ) method by verifying such items as land boundaries and objects buried underground.

The reasonable price range (P1˜P2) is calculated according to the example block diagram as shown in Drawing 4.

The income price range (c1˜c2) obtained by the DCF method is calculated by combining various wide-ranging inputs, such as an estimated price range (a1˜a2) calculated in accordance with the cost method by entering multiple inputs, a income price range (b1˜b2) calculated in accordance with the profit reduction method by entering multiple inputs, and as well, a discount rate range (d1˜d2), a terminal rate range (e1˜e2), a rent amendment rate range (f1˜f2), and a vacancy rate range (g1˜g2) in the case of commercial sites. The reasonable price range (P1˜P2) is determined after adjusting these various ranges.

An example of the reasonable price range (P1˜P2) determination method is to set the minimum appraised amount a1 and the maximum appraised amount c2 as the minimum amount P1 and the maximum amount P2 respectively, as illustrated. Alternatively, a range overlapping two or more ranges obtained by the aforesaid multiple pricing methods is also available. In this case, the appraised amount a1 and the appraised amount b2 are set as the minimum amount P1 and the maximum amount P2 respectively.

(4) The seller registers the subject matter in question in the network market by presenting a desired selling price X falling within the reasonable price range (P1˜P2) to the Market Company or by approving such reasonable price range (P1˜P2).

(5) The outline of the registered subject matter and the reasonable price range (P1˜P2) are disclosed by the server to members 1˜m. Such disclosure is made to all members 1˜m. The confidentiality of detailed information is maintained by disclosing only the outline of the subject matter and the reasonable price range (P1˜P2).

(6) A member who desires to purchase (members 1, 3, and 4 in the illustrated example) undergoes a procedure to be registered by a server as a prospective buyer of the subject matter in question.

Information is presented only to members 1, 3, and 4 as prospective buyers thereafter.

(7) The business outline and the results of executing due diligence are presented by the server to members 1, 3, and 4 and the Market Company determines an adjustment rate (a) by, for example, application of the empirical rule. The adjustment rate (a) is, as described hereunder, used as a barometer to determine whether or not it is possible to adjust the difference between the desired selling price and the desired buying price.

It may suffice to limit the presentation of the business outline and the results of executing due diligence to those items essential for substantiating the reasonable price range (P1˜P2). At this point, the network market commences (opens).

(8) Members 1, 3, and 4 present their desired buying prices Y1, Y3, and Y4 respectively, falling within the reasonable price range (P1˜P2), to the server from their own terminals.

Upon providing a set period of time, there is the option of either inviting, or simultaneously arranging for the presentation of the desired buying prices Y1, Y3, and Y4.

(9-1) In the event that the maximum desired buying price Y is higher than the desired selling price X, the average of the desired selling price X and the maximum desired buying price Y is presented by the server to both the seller and the prospective buyer who presented the maximum desired buying price Y, and a contract is thereafter executed.

(9-2) In the event that the maximum desired buying price Y is lower than the desired selling price X and the difference is within the adjustment rate (a), the average of the desired selling price X and the maximum desired buying price Y is presented by the server to both the seller and the prospective buyer who presented the maximum desired buying price Y, an adjustment is made by the Market Company, and a contract is thereafter executed.

(9-3) In the event that the maximum desired buying price Y is lower than the desired selling price X and the difference is higher than the adjustment rate (a), the desired selling price X is reviewed and the network market process is executed again.

The aforesaid average price may be calculated as an arithmetic mean or by any other predetermined calculation method.

In a variation of the execution of this invention, the Market Company presents yields to the seller in step (3).

In other words: (3) The Market Company presents a reasonable price range and yields to the seller as guidelines for determining the desired selling price by executing an appraisal of the business outline and due diligence with respect to the subject matter; employing a real estate appraisal evaluation (assessment) method; calculating a reasonable price range based on a matrix appraisal; and calculating the yields pertaining to net profit amounts corresponding to two or more prices which shall minimally include the upper and lower limits within the reasonable price range in question, or corresponding to given prices relative to regularly fixed prices within such reasonable price range, with such prices constituting the principal amounts.

In addition, the Market Company presents the yields to members in step (5).

In other words: (5) The Market Company discloses the outline of the subject matter, the reasonable price range, and the aforesaid yields to the members.

The use of such yields is effective because it helps individual or inexperienced investors determine more easily whether to invest in subject matters situated in different areas or which otherwise possess different characteristics.

The following is an embodiment of a calculating method of the reasonable price range in step (3) that employs the aforesaid DCF method.

To conduct a trial calculation of the profitable price, it is required that the profitable price obtained from among variable items, for example the rent estimate (variable 1), is set at either the upper or lower limit or a random value falling between both limits, and a variable item based on another factor is, for example, fixed as the intermediary value between both limits. An example of the result of calculations is shown in Table 1.

TABLE 1
(Unit: 100,000,000 yen)
Income Approach Price

| | | | | | | | |
|---|---|---|---|---|---|---|---|
| Variable 1 | | 38 | | | 47 | | |
| Variable 2 | | | | 43 | | 51 | 58 |
| Variable 3 | 35 | | 40 | 43 | | 51 | |
| Variable n | . . . | | | | | | |

Variable 1 Ex. the rent estimate Variable 2: Ex. the management cost

Provided, however, that variables constitute such costs as future rents, and management costs. The appraisal of a building reflects the results of the execution of due diligence.

Although not shown in the Table, the estimated price or comparison obtained by any method other than the DCF method may be added to the matrix appraisals.

After examining the results of the matrix appraisals as per Table 1 and interpreting the overlapping ranges, the reasonable price range falling within the scope of the income price is set between 4.3 and 5.1 billion yen.

If the net profit is 300 million yen in this example, the yield is 7.0-5.9% as a result of dividing the net profit of 300 million yen by the reasonable price range of 4.3-5.1 billion yen.

When disclosing the yields in question, it is appropriate if the yields corresponding to prices set at small intervals within the reasonable price range as shown In Table 2 is easy to understand.

TABLE 2
(Unit: 100,000,000 yen)

| | | | | | | | | | |
|---|---|---|---|---|---|---|---|---|---|
| Price | 43 | 44 | 45 | 46 | 47 | 48 | 49 | 50 | 51 |
| Rate | 7% | 6.8% | 6.7% | 6.5% | 6.4% | 6.3% | 6.1% | 6% | 5.9% |

In a variation of the execution of this invention, the market yield is disclosed as a guideline to assist the seller and the buyer in determining prices.

That is to say, a single seller and multiple buyers are selected from among investors, a virtual subject matter is created, an assumed trade price of the virtual subject matter in question is determined by the aforesaid steps, and the yield pertaining to the net profit (the market yield) is calculated with such assumed trade price constituting the principal amount. Multiple market yields that have been obtained against multiple virtual subject matters are disclosed together with the outline of the subject matter in question.

The aforesaid virtual subject matters can cover apartment housing for lease and commercial premises, but this description is limited to office buildings for investment.

At first, create virtual tenant buildings according to city, area, and number of years since completion of construction, with locations and sizes fixed. As concerns the sizes of the buildings, they may correspond to the following example. The lot size may be 300-1,000 tsubo (approximately 990 m²-3,300 m²); and the building size, 2,000-10,000 tsubo (approximately 6,600 m²-33,000 m²). The number of years since completion of construction may be 5-30 years. The locations may be in big cities according to area, with districts constituting the sites of prefectural offices or other similar-sized cities.

Next, research the market rent and vacancy rate in each city or area, fix the lease description for each virtual tenant building, and set the building management cost and common maintenance charge for each virtual subject matter. In addition, estimate the life cycle cost that incorporates as well the earthquake risk applicable to the grade of each building. The operating profit of the building is also checked.

The appraisal work conducted in accordance with the DCF method, as such is similarly conducted on actual subject matters, can be executed according to the above steps.

The assumed trade price of the virtual subject matter in question is determined in accordance with the aforesaid steps, and the yield pertaining to the net profit (market yield) is calculated with the assumed trade price in question constituting the principal amount.

The calculated market yield is always disclosed together with the outline of the subject matter in question, and is reassessed in a timely manner in the network market while reflecting interest rate trends.

In actual contract negotiations, the intermediary work is facilitated by uncovering and presenting to the seller and the buyer one or more market yields possessing outlines resembling the subject matter in question. Alternatively the seller may determine the desired selling price by knowing a market yield possessing an outline resembling the subject matter he or she desires to sell. Similarly, the buyer may be able to employ such market yield as a guideline to determine the desired buying price.

(Embodiment)

An embodiment to enable trial calculations of the matrix appraisals by the DCF method and the setting of the range price to be presented in the network market is herein described. The subject matter in this case is a high-rise office lease building.

The range price has been calculated in accordance with the matrix appraisals upon assuming that the renewal rents and costs of building business are fixed, and predicting that the discount rate, capitalization yield, new rents, and operating rate are all fluctuating items.

[Matrix Appraisals]

1. Income and Expenditures of the Building Business

Income and expenditures of the building business pertaining to this subject matter in the past 3 years are as shown in Table 3.

(1) The lease agreement with each tenant is not disclosed. The average monthly rent for an office is ¥7,580/m² (¥25,000/tsubo), and the common maintenance charge is ¥2,200/m² (¥7,400/tsubo).

(2) As concerns usage of the building, 7.6% of the contracted area is occupied by stores (commodities shops and restaurants), and not by offices.

(3) Other income may be earned from such per-use fees as parking fees, and rental charges for conference rooms.

(4) The vacancy rate was as high as 13% as of the end of 1999, but has recovered to 3% at the time of the appraisals (at the end of 2000).

TABLE 3
(Unit: 1,000,000 yen)

| | 1997 | 1998 | 1999 | |
|---|---|---|---|---|
| Revenues | | | | |
| Rent | 9,100 | 9,050 | 8,600 | 8,916 |
| Common Maintenance Charge | 2,600 | 2,600 | 2,500 | 2,567 |
| Other income | 480 | 510 | 510 | 500 |
| Total | 12,180 | 12,160 | 11,610 | 11,983 |
| Expenses | | | | |
| Management cost | 340 | 340 | 330 | 337 |
| Outsourcing cost | 790 | 800 | 770 | 787 |
| Utilities | 370 | 340 | 260 | 323 |
| Taxes | 1,250 | 1,070 | 1,070 | 1,130 |
| Property Insurance Premiums | 35 | 31 | 22 | 29 |
| Others | 7 | 0 | 0 | 2 |
| Total | 2,792 | 2,581 | 2,452 | 2,608 |
| Net income | 9,388 | 9,579 | 9,158 | 9,375 |
| Expense rate | 23% | 21% | 21% | 22% |
| Vacancy rate | 3% | 10% | 13% | 8.7% |

2. Analysis and Estimate of Income

(1) Rent Trends in the Area

The subject matter in question is located in an office zone in a secondary city center of Tokyo where skyscrapers stand close together. There is in excess of 1,660,000 m² of gross lease space in a building topping 30 other buildings in the area, with 80% thereof constituting units for lease. The level of rent (including joint maintenance charges) is ¥20,000-35,000/tsubo. It goes without saying that the rent for skyscrapers is normally higher than that for ordinary buildings. In addition, the rent rankings for skyscrapers, unlike for other types of buildings, is set regardless of the number of years that have passed since construction of the building.

The level of rents for competitive skyscrapers is shown in Table 4.

TABLE 4
(2000 investigation)

| | | | Agreement |
|---|---|---|---|
| | Total of | Total area | Rent |
| Building name | the Floors | (square meters) | (Yen/3.3 m²) |
| L Tower | 31 | 26,028 | 33,000 |
| The center building | 54 | 55,377 | 30,000 |
| S Tec | 28 | 14,163 | 30,000 |
| MO | 30 | 27,361 | 30,000 |
| N | 50 | 36,086 | 30,000 |
| M1 | 55 | 54,358 | 34,000 |
| S | 52 | 53,370 | 30,000 |
| NS | 30 | 50,446 | 25,000 |
| I Tower | 44 | 66,463 | 30,000 |
| NO1 | 26 | 27,556 | 23,500 |
| The park | 52 | 79,903 | 26,500 |
| Green | 29 | 15,823 | 26,500 |
| M2 | 27 | 21,570 | 28,000 |
| The square | 31 | 13,536 | 22,000 |
| Average rent | | 29,134 | |

Agreement Rent includes Common Maintenance Charge. (Yen/3.3 m²)

(2) Analysis of Terms and Conditions of Lease Pertaining to the Subject Matter

The ¥7,600/m² (¥25,000/tsubo) average monthly office rent for the subject matter and the ¥2,200/m² (¥7,400/tsubo) common maintenance charge add up to ¥9,800/m² (¥32,400/tsubo), a figure that is higher than the average rent of competitive buildings by 11%.

The rents in the area have remained at the same level for a number of years and this trend is anticipated to continue for the time being As for the market rent (including common maintenance charge) of the embodiment, however, three scenarios are assumed. The first scenario assumes that the current new rent of ¥30,000/tsubo remains at the same level for the time being; the second scenario assumes that the rent rises by 3% every two years; and the third scenario assumes that the rent declines by 3% every two years. Assuming that tenants who pay rents significantly higher than the market rent withdraw from their units in succession, amendments to rents as they pertain to the renewal period for tenants who renew their contracts is estimated to remain at the same level.

Detailed information pertaining to shops is not disclosed, but the situation is likely to remain stable for the time being due to increases in the population of the office town and vicinity, which includes underground areas. New rents, however, are estimated to fall due to the increase in the number of competitive underground shops.

Parking fees and other such charges are assumed to remain on the same level as they currently fall within the area standards.

(3) Rent Predictions (Setting of Income Conditions)

The net working rate is assumed as per Table 5 by comparing the average vacancy rate of the subject matter in the past several years with the average vacancy rate of competitive buildings in this area.

TABLE 5

| | Office | Store | Total |
|---|---|---|---|
| Usable Area | 97,230 | 7,770 | 105,000 |
| | square meters | square meters | square meters |
| Vacancy Area | 2916 | 231 | 3150 |
| | square meters | square meters | square meters |
| Operation Area | 94,314 | 7,537 | 101,851 |
| | square meters | square meters | square meters |

New Rent (includes Common Management Charge)

30,000 yen/3.3 m² 30,000 yen/3.3 m²

Amendments to New Rent

| | |
|---|---|
| Office) | Remaining on the same level for 5 years |
| | Rising by 3% every 2 years |
| | Declining by 3% every 2 years |
| Store) | Remaining on the same level for 5 years |
| | Rising by 3% every 2 years |
| | Declining by 3% every 2 years |

| | |
|---|---|
| Contract Rent | 30,942 yen/3.3 m² 37,700 yen/3.3 m² |

Amendments to Contract Rent

| | |
|---|---|
| Office) | Remaining on the same level for 5 years |
| Store) | Declining by 3% every year for 5 years |

Rent loss
Tenant Cancellation Rate

| | |
|---|---|
| Office) | Canceling by 20% every year. Canceling by 10% every year. |
| Store) | Canceling by 20% every year. Canceling by 10% every year. |

| | | |
|---|---|---|
| Vacancy Period | 6 months | 6 months |

Deposit

| | |
|---|---|
| Office) | The due amount of the rent of 12 months |
| Store) | The due amount of the rent of 12 months |

Other Income Fluctuation Rate

| | |
|---|---|
| Office) | Remaining on the same level for 5 years |
| Store) | Remaining on the same level for 5 years |

3. Analysis and Estimation of Costs

(1) Assessment of Expenditure Items

The average of income and expenditures for business pertaining to the subject matter in the past 3 years is as per Table 6. Utilities, taxes, property insurance premiums, and other expenditures are expressed in actual amounts, and no particular problems were encountered. Analysis targets the management cost and outsourcing cost. These costs total 1,124 million yen, constituting 9.4% of the gross income and 43.8% of the common maintenance charge, which fall within the standard values for income and expenditures pertaining to building business, and therefore, it is judged that no revision is needed. The expense rate (the ratio of gross expenditures to gross income) stands at 22%, which falls within the standard expense rate for skyscrapers.

TABLE 6
(Unit: 1,000,000 yen)

| Revenues | Average for past 3 years |
|---|---|
| Rent | 8,916 |
| Common Maintenance Charge | 2,567 |
| Other Income | 500 |
| Total | 11,983 |
| Expenses | |
| Management Cost | 337 |
| Outsourcing cost | 787 |
| Utilities | 323 |
| Taxes | 1,130 |
| Property Insurance Premiums | 29 |
| Others | 2 |
| Total | 2,608 |
| Net Income | 9,375 |
| Vacancy Rate | 8.7% |
| Expense Rate | 22% |

(2) Life Cycle Cost

According to the “Building Engineering Report” pertaining to the subject matter, 25 years have passed since construction of the subject matter. Large scale repairs, including construction of the atrium, were undertaken a year before at a cost of 4 billion yen, and it has been determined that an accumulated fund of 7 million yen over the next 10 years is necessary upon anticipating that costs for repairing facilities will continue to be incurred in the future as well.

7 million yen constitutes approximately 1.4% of the re-acquisition cost of the subject matter, which is judged a reasonable level, and therefore, it has been determined that 7 million yen is to be processed in the accounts as an expenditure item without revision.

(3) Estimation of Expenditure Items

An estimation of expenditure items has been performed as per Table 7.

TABLE 7
(Unit: 1,000,000 yen)

| | First year | Fluctuation Rate |
|---|---|---|
| Management & Maintenance Cost | 1,124 | Rising by 1% every year |
| Taxes | 1,130 | Same level for 5 years |
| Property Insurance Premiums | 29 | Same level for 5 years |
| Utilities | 323 | Same level for 5 years |
| Repair Reserved Fund | 700 | Same level for 5 years |
| Others | 2 | Same level for 5 years |
| Total | 3,308 | |
| Agency Fee (Change Expenses) | | |

4. Assessment of the Discount Rate (Going Rate: GR) and the Term-end Capitalization Rate (Terminal Rate: TR)

(1) Market Yield

A common barometer for investors is the capitalization yield (cap rate), which indicates the ratio of net profit (NOI) to trade price. This yield includes a relative comparison with yields of financial products, land value trends, characteristics of the city or area where the subject matter is located, the grade of the building, and the number of years that have passed since the construction of the building.

Although data for the profitable real estate trade in Japan has not yet been adjusted because it has just commenced, trade yields pertaining to subject matters purchased for integration into funds is being made aware of, with focus placed on yields to be derived from the formation of products pertaining to an originator's real estate securitization and REIT.

Recently, the acquisition of investment real estate for the purpose of integration into the fund overheated. The capitalization yield has already dropped to approximately 4% for the highly graded buildings located in the class A office zone of Marunouchi and Otemachi in Tokyo.

(2) How to Think of the Discount Rate

The discount rate (GR) is calculated according to the accumulation method, which adds a real estate risk premium to the long-term yields of financial products, or according to another method, which divides the asset into the funds on hand and borrowed funds and combines the standard interest rate pertaining to the borrowed funds and the expected yield from funds on hand. These methods can be adopted for the purpose of verification but cannot be adopted as the main method because the risk premium cannot be assessed and also because there is an inconsistency in deciding to divide an asset into funds on hand and borrowed funds when acquiring real estate for the purpose of securitization.

Since the capitalization yield (C market yield) is calculated by adding and subtracting the discount rate (GR) and the fluctuation rate (r) of the real estate during the discount period, there is another method by which the discount rate (GR) can be calculated backwards, but it Is not deemed an absolute method because of the difficulty of estimating the fluctuation rate (r), and the issue of the relationship with the terminal rate (TR) at term-end.

TABLE 8

| GR | 4.5% | 5% | 5.5% | 6% | 6.5% |
|---|---|---|---|---|---|
| TR | | | | | |
| 5% | * | | | | |
| 5.5% | * | * | | | |
| 6% | | * | * | | |
| 6.5% | | | * | * | |
| 7% | | | | * | * |
| 7.5% | | | | | * |

(3) Determination of the Yield (or the Rate)

Since the subject matter is a class A building located in an office zone in Tokyo, the yield (range) is calculated as per Table 8 by incorporating the market yields from and future reactions to an overheating fund bubble.

5. Trial Calculations Conducted in Accordance with a Matrix Appraisal

60 trial calculations have been executed in the appraisal with variables according to 3 rent amendment rates (3%, 0% and -3%), 2 cancellation rates (10% and 20%), and 10 combinations of the discount rate (GR) and the terminal rate (TR). The results from executing the trial calculations are shown in the income price table compiled in accordance with the DCF method in Table 9.

TABLE 9
(Unit: yen)
Rate GR 4.5%

| TR New Rent | | −3% | 0% | +3% |
|---|---|---|---|---|
| 5.0% | Tenant Cancellation Rate | | | |
| | 10% | 161,300,000,000 | 162,200,000,000 | 163,000,000,000 |
| | 20% | 145,900,000,000 | 147,400,000,000 | 148,900,000,000 |
| 5.5% | Tenant Cancellation Rate | | | |
| | 10% | 150,100,000,000 | 150,900,000,000 | 151,600,000,000 |
| | 20% | 135,800,000,000 | 137,200,000,000 | 138,600,000,000 |

(Unit: yen)
Rate GR 5.0%

| TR New rent | | −3% | 0% | +3% |
|---|---|---|---|---|
| 5.5% | Tenant Cancellation Rate | | | |
| | 10% | 146,400,000,000 | 147,100,000,000 | 147,900,000,000 |
| | 20% | 132,500,000,000 | 133,800,000,000 | 135,100,000,000 |
| 6.0% | Tenant Cancellation Rate | | | |
| | 10% | 137,200,000,000 | 137,900,000,000 | 138,600,000,000 |
| | 20% | 124,200,000,000 | 125,500,000,000 | 126,700,000,000 |

(Unit: yen)
Rate GR 5.5%

| TR New rent | | −3% | 0% | +3% |
|---|---|---|---|---|
| 6.0% | Tenant Cancellation Rate | | | |
| | 10% | 133,900,000,000 | 134,600,000,000 | 135,200,000,000 |
| | 20% | 121,200,000,000 | 122,500,000,000 | 123,700,000,000 |
| 6.5% | Tenant Cancellation Rate | | | |
| | 10% | 126,400,000,000 | 127,000,000,000 | 127,600,000,000 |
| | 20% | 114,500,000,000 | 115,600,000,000 | 116,700,000,000 |

(Unit: yen)
Rate GR 6.0%

| TR New rent | | −3% | 0% | +3% |
|---|---|---|---|---|
| 6.5% | Tenant Cancellation Rate | | | |
| | 10% | 123,400,000,000 | 124,000,000,000 | 124,600,000,000 |
| | 20% | 111,800,000,000 | 112,900,000,000 | 114,000,000,000 |
| 7.0% | Tenant Cancellation Rate | | | |
| | 10% | 117,100,000,000 | 114,900,000,000 | 118,200,000,000 |
| | 20% | 106,200,000,000 | 107,200,000,000 | 108,200,000,000 |

(Unit: yen)
Rate GR 6.5%

| TR New rent | | −3% | 0% | +3% |
|---|---|---|---|---|
| 7.0% | Tenant Cancellation Rate | | | |
| | 10% | 114,300,000,000 | 114,900,000,000 | 115,500,000,000 |
| | 20% | 103,700,000,000 | 104,700,000,000 | 105,700,000,000 |
| 7.5% | Tenant Cancellation Rate | | | |
| | 10% | 109,100,000,000 | 109,600,000,000 | 110,100,000,000 |
| | 20% | 98,900,000,000 | 99,900,000,000 | 108,800,000,000 |

[Range Price]

1. Analysis by the Real Estate Index (or Property Index)

The real estate index (overall capitalization Rate) pertaining to the subject matter is calculated as follows:

(1) Virtual Building

Identify a number of points (example: commercial point on announced land) for each city or area, establish a building site on a map on the network in accordance with the size of the land (examples: 300 m², 1,000 m², or 2,000 m²) to be set at random on each such point, and construct a virtual building (2,400 m², 8,000 m² or 16,000 m²) on the network in accordance with the working capacity rate (example: 800%) on each such point. Provided, however, that one benchmark building is selected in each area.

(2) Setting of Terms and Conditions for Lease

Next, the net profit for each virtual building is determined through measures pertaining to the assessment of the terms and conditions for lease (rent, common maintenance charges, deposit, vacancy rate, amendment rate) of each virtual building by an office broker who supplies data on such factors as market rents (taking into account common maintenance charges) and vacancy rates for each city or area, measures pertaining to trial calculations of net profits based on the assumption that tenants are attracted to each virtual building, measures pertaining to the acquisition of data regarding standard management costs for each virtual building from building management companies, and measures pertaining to trial calculations of the standard life cycle costs of the virtual buildings conducted by a general contractor or design office.

(3) Matrix Appraisal

The Net Company executes the matrix appraisals in accordance primarily with the DCF method by anticipating future rents, vacancy rates, and costs based on the currently determined net profit. It goes without saying that the going rate (discount rate) and terminal rate (overall capitalization rate at the time of resale) at the time of applying the DCF method is normally calculated within the given range.

The market is created on the network by indicating the range price for each virtual building thus calculated together with the yield calculated from the currently determined net profit.

(4) Participation of Members

One approach involves inviting investors who actually invest in real estate (including real estate companies, life insurance companies, property insurance companies, foreign capital affiliated companies, trading companies and building lease companies); and market watchers, such as securities companies, rating organizations, auditing organizations, and real estate appraisal organizations, to be members and to participate in the virtual network market as investors. Provided, however, that only investor members are entitled to engage in trade in the virtual network market while market watcher members are entitled to the disclosures of results only.

(5) Pricing Method and Overall Capitalization Rate

As concerns index determination, multiple members determine the buying price as buyers on the virtual network market. Two methods are available. One is to calculate the overall capitalization rate showing the relationship of the current net profit to both the maximum price and average price in consideration of the standard deviation by the statistical method. Another is to calculate the overall capitalization rate showing the relationship of the current net profit to the equilibrium price obtained by repeated revisions of prices on the network market by one or more sellers and multiple buyers.

(6) Calculation of the Property (Overall) Yield Rate

An index is produced by the latter method for the purpose of network market.

As concerns the real estate index, it is common to calculate a property capitalization yield rate combining the income yield (return) and the capital yield (return) In this index, the property capitalization yield rate is calculated as follows, while an example of a conventional calculation method is shown in Table 6.

First index

Equilibrium price in the virtual network market P

Net profit at that point in time I

Index I/P=R (overall capitalization rate)

Second Index

Second equilibrium price in the virtual network market P2

Net Profit at that point in time I2

Index I2/P2=R2 (overall capitalization rate)

Income Yield (Return) I2/P=X

Capital Yield (Return) (P2−P)/P=Y

Property (Overall) Yield Rate (Return) X+Y

(7) Advantages of this Index

Any changes in real estate prices and yields due to fluctuations of such variables as interest rates and stock prices are indicated in a timely fashion.

Any changes in real estate prices and yields due to fluctuations of such variables as rents, vacancy rates, and expenses in the real estate market are indicated in a timely fashion.

The principal price constitutes the profitable price, which distinguishes this index from other existing real estate indices.

Because of the virtual nature of the virtual building, it is possible to freely set the region, size and grade of the building, and number of years that have passed since the construction of the building, and to analyze changes in real estate prices and yields corresponding to risks.

The above steps provide the nearest result of 5.8% (6.2% average buying price and 6.4% minimum buying price) for the real estate index (overall capitalization rate) in the area where the subject matter is located.

2. Matrix Appraisal and Rate

The following are the overall capitalization rate corresponding to the listed prices for the income price calculated in accordance with the matrix appraisal, with the current net profit of the building at ¥8,311,173,000, from which the broker's commission has been deducted.

3. Determination of the Range Price

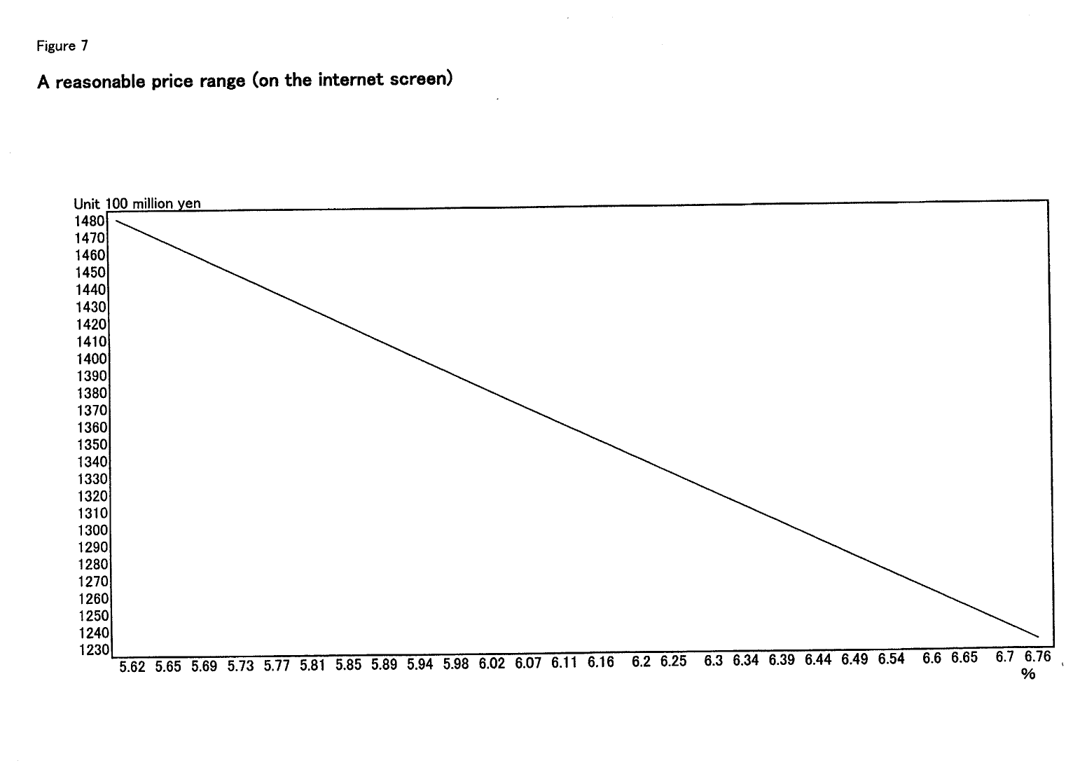

The range price is determined with guidelines consisting of the real estate index (overall capitalization rate) of large buildings located in the same area as the subject matter at 5.8%, the average buying price at 6.2%, and the minimum buying price at 6.5%, while also taking into consideration the results of the matrix appraisals. The range prices are indicated in Table 11 and FIG. 7.

TABLE 10

| Price | Upper limit | Minimum |
|---|---|---|
| Overall Capitalization Rate | 163,000,000,000 yen | 98,900,000,000 yen |
| | 5.1% | 8.4% |

TABLE 11

| | Upper limit | Minimum |
|---|---|---|
| Price | 147,900,000,000 yen | 123,400,000,000 yen |
| Overall Capitalization | 5.6% | 6.7% |
| Rate | | |

Effects of the Invention

This invention is a system that unifies appraisals of real estate and the market function, and enables the seller and the buyer to mutually see the process in which the trade price is determined while exchanging information directly on the display established on the network, thereby generating the following multiple effects.

The disclosure of information to multiple buyers is executed simultaneously, which enables speedy and efficient trading of real estate.

The monopoly of trade information held by brokers is eliminated, which leads to a reduction in brokerage fees.

The process of price determination can be seen on the display via the network, which assures transparency of trade.

The seller is likely to quote the selling price at the upper end of the range price as he or she desires to sell at the highest possible price, and the buyer is likely to quote the buying price at the lower end of the range price as he or she desires to buy at the lowest possible price. This situation will initially place a large gap between both prices. However, both prices move towards each other because both parties will revise their prices instantly in the network market and present the revised prices repeatedly until both prices are in equilibrium. Alternatively, when the difference falls within the fixed adjustment rate, the average value can be automatically set as the equilibrium price.

The seller and multiple buyers may present their prices at the same time, or such prices may be disclosed to all parties at a given time. Alternatively, the system can be set to enable the prices presented by each buyer to be disclosed or not disclosed to other buyers where multiple buyers are involved.

Purchases and sales of real estate comprising the Real Estate Investment Trust (REIT) can be smoothly engaged in, thereby stabilizing the distribution of the Real Estate Investment Trust (REIT) itself.

Although equity pertaining to unlisted real estate securitization products are not placed in circulation, in contrast to the Real Estate Investment Trust (REIT), it is possible to engage in trade in such equity on the network market (secondary market).

The range price indicates the reasonable upper and lower limits, which restricts any trade price from being higher than the upper limit and lower than the lower limit, thereby eliminating the practices of speculative trading and dumping.

The real estate index of this invention established in the network market by the appraiser executes the matrix appraisals on groups of virtual buildings for each region; reflects the obtained range price of the virtual buildings on the aforementioned network market; and indicates the yield generated between the current assumed net profit and the buyer's desired buying price as determined through the price determination process of the network market, or the standard desired buying price as calculated by the statistical method. The index of this invention generates the following multiple effects.

It is possible to reflect in a timely fashion in financial markets the effects of constantly fluctuating interest rates, stock prices, credit prices, exchange rates, and other such variables.

It is possible to reflect in a timely fashion the effects of fluctuations in rents, vacancy rates, and costs occurring in real estate markets.

In order to measure changes in yields on the network market, it is possible to freely create virtual buildings in different regions, and with different building grades and varying numbers of years that have passed since construction.

In order to improve the accuracy of the matrix appraisals, it is possible to grasp investment yields in a timely fashion.

It is possible to employ the index as an investment barometer of the Real Estate Investment Trust (REIT).

It is possible to grasp the rate of return of the capital gain by continuously developing the real estate index.

What is claimed is:

1. A real estate network market system that is comprised of the following steps:
(1) A step that involves the measures by which an investor is registered as a member.
(2) A step that involves the measures by which a seller presents an outline of the subject matter to the Market Company.
(3) A step that involves the measures by which the Market Company presents a reasonable price range to the seller by executing an analysis of the business outline pertaining to the subject matter and due diligence with respect to the subject matter, employing a real estate appraisal assessment method, and calculating a reasonable price range pertaining to the subject matter based on a matrix appraisal.
(4) A step that involves the measures by which the seller presents a desired selling price falling within the reasonable price range to the Market Company.
(5) A step that involves the measures by which the Market Company discloses an outline of the subject matter and the reasonable price range to members. (6) A step that involves the measures by which a requesting member is registered by the Market Company as a prospective buyer of the subject matter in question.
(7) A step that involves the measures by which the Market Company presents an outline of the subject matter, the results of executing due diligence, and the matrix assessment of the subject matter to the prospective buyer and determines the adjustment rate.
(8) A step that involves the measures by which the prospective buyer presents a desired buying price falling within the reasonable price range to the Market Company.
(9) A step that involves the measures to take effect in the event that the maximum desired buying price is lower than the desired selling price and the difference is higher than the adjustment rate, by which the seller shall revise the desired selling price and present it again to the Market Company and by which each prospective buyer shall revise their desired buying price and present it again to the Market Company until the desired selling price and the maximum desired buying price are in equilibrium within the adjustment rate.
(10) A step that involves the measures to take effect in the event that the maximum desired buying price is higher than the desired selling price, by which the average of the desired selling price and the maximum desired buying price is presented to the seller and the prospective buyer who presented the maximum desired buying price; and measures to take effect in the event that the maximum desired buying price is lower than the desired selling price and the difference is within the adjustment rate, by which the average of the desired selling price and the maximum desired buying price is presented for adjustment to the seller and the prospective buyer who presented the maximum desired buying price.

2. A network market system that is comprised of the following steps:
(1) A step that involves the measures by which the Market Company calculates a reasonable price range and presents it to the seller and prospective buyer.
(2) A step that involves the measures by which the seller presents a desired selling price falling within the reasonable price range to the Market Company.
(3) A step that involves the measures by which the prospective buyer presents a desired buying price falling within the reasonable price range to the Market Company.
(4) A step that involves the measures to take effect in the event that the maximum desired buying price is lower than the desired selling price and the difference is higher than the adjustment rate, by which the seller shall revise the desired selling price and present it again to the Market Company, and by which each prospective buyer shall revise their desired buying price and present it again to the Market Company until the desired selling price and the maximum desired buying price are in equilibrium within the adjustment rate.
(5) A step that involves the measures to take effect in the event that the maximum desired buying price is higher than the desired selling price, by which the average of the desired selling price and the maximum desired buying price is presented to the seller and the prospective buyer who presented the maximum desired buying price: and the measures to take effect in the event that the maximum desired buying price is lower than the desired selling price and the difference is within the adjustment rate, by which the average of the desired selling price and the maximum desired buying price is presented for adjustment to the seller and the prospective buyer who presented the maximum desired buying price.

3. A real estate network market system that, via a server connected to the network by the Market Company, can be accessed by registered members via the network and can also be accessed by voluntary sellers via the network.
The first step is a step that involves measures pertaining to the inputting of an outline of the subject matter by the seller; measures pertaining to the calculation performed by the server of a reasonable price range in accordance with the matrix assessment and presentation thereof to the seller; and measures pertaining to the presentation by the seller of a desired selling price.
The second step is a step that involves measures pertaining to the disclosure of the outline of the subject matter and the reasonable price range by the server to members, measures pertaining to the registration of a desiring member in the server as a prospective buyer of such subject matter, and measures pertaining to the presentation of a desired buying price by the prospective buyer to the server.
The third step is a step that involves measures to take effect in the event that the maximum desired buying price is lower than the desired selling price and the difference is higher than the adjustment rate, by which the seller shall revise the desired selling price and present it again to the server, and by which each prospective buyer shall revise their desired buying price and present it again to the server until the desired selling price and the maximum desired buying price are in equilibrium within the adjustment rate.
The fourth step is a step that involves measures to take effect in the event that the maximum desired buying price is higher than the desired selling price, or in the event that the maximum desired buying price is lower than the desired selling price and the difference is within the adjustment rate, by which the average of the desired selling price and the maximum desired buying price is presented by the server to the seller and the prospective buyer who presented the maximum desired buying price.

4. A network market system that can be accessed by sellers and prospective buyers via the server connected to the network by the Market Company as well as a system that involves measures pertaining to the calculation performed by the server of a reasonable price range in accordance with the matrix assessment and presentation thereof; measures pertaining to the presentation by the seller of a desired selling price; measures pertaining to the presentation of a desired buying price by the prospective buyer; measures to take effect in the event that the maximum desired buying price is lower than the desired selling price and the difference is higher than the adjustment rate, by which the seller shall revise the desired selling price, and by which each prospective buyer shall revise their desired buying price to be respectively and repeatedly presented to the Market Company until the desired selling price and the maximum desired buying price are in equilibrium within the adjustment rate; and measures to take effect in the event that the maximum desired buying price is higher than the desired selling price, or in the event that the maximum desired buying price is lower than the desired selling price and the difference is within the adjustment rate, by which the average of the desired selling price and the maximum desired buying price is presented by the server to the seller and the prospective buyer who presented the maximum desired buying price.

5. The real estate network market system described in claims 1 and 3, characterized by the manner in which a reasonable price range is calculated in accordance with the aforesaid matrix assessment, and can constitute a range inclusive of a range obtained by multiple pricing methods.

6. The real estate network market system described in claims 1 and 3, characterized by the manner in which a reasonable price range is calculated in accordance with the aforesaid matrix assessment, and can be a range overlapping two or more ranges obtained by multiple pricing methods.

7. A real estate network market system that is comprised of the following steps:
(1) A step that involves measures by which an investor is registered as a member.
(2) A step that involves measures by which a seller presents an outline of the subject matter to the Market Company.
(3) A step that involves measures by which, in order to present a reasonable price range and the aforesaid yield to the seller as a guideline to determine the desired selling price, the Market Company executes an analysis of the business outline pertaining to the subject matter and due diligence with respect to the subject matter; employs a real estate appraisal assessment method; calculates a reasonable price range of the subject matter based on a matrix assessment; and calculates the yields pertaining to net profit amounts corresponding to two or more prices which shall minimally include the upper and lower limits within the reasonable price range in question, with such prices constituting the principal amounts.
(4) A step that involves measures by which the seller proposes a desired selling price within the reasonable price range to the Market Company.
(5) A step that involves measures by which the Market Company discloses an outline of the subject matter, a reasonable price range, and the aforesaid yield figures to members.
(6) A step that involves measures by which a desiring member is registered by the Market Company as a prospective buyer of such subject matter.
(7) A step that involves measures by which the Market Company presents a business outline, the results of executing due diligence, and the matrix assessment to the prospective buyer and determines the adjustment rate.
(8) A step that involves measures by which the prospective buyer presents a desired buying price falling within the reasonable price range to the Market Company.
(9) A step that involves measures to take effect in the event that the maximum desired buying price is lower than the desired selling price and the difference is higher than the adjustment rate, by which the seller shall revise the desired selling price and present it again to the Market Company and by which each prospective buyer shall revise their desired buying price and present it again to the Market Company until the desired selling price and the maximum desired buying price are in equilibrium within the adjustment rate.
(10) A step that involves measures to take effect in the event that the maximum desired buying price is higher than the desired selling price, by which the average of the desired selling price and the maximum desired buying price is presented to the seller and the prospective buyer who presented the maximum desired buying price; and measures to take effect in the event that the maximum desired buying price is lower than the desired selling price and the difference is within the adjustment rate, by which the average of the desired selling price and the maximum desired buying price is presented for adjustment to the seller and the prospective buyer who presented the maximum desired buying price.

8. The real estate network market system described in claims 1 and 7, characterized by the manner in which the aforesaid matrix assessment includes the DCF method; and in which the aforesaid yield is presented together with the deduction rate employed by the DCF method, the terminal rate employed by the DCF method, and one or more yield figures selected from a set consisting of yields calculated based on profitable prices obtained by the DCF method.

9. The real estate network market system described in claims 1 and 7, characterized by the manner in which the Market Company selects multiple buyers from among investors; creates a virtual subject matter; executes each and every step of the real estate network market system for such virtual subject matter; and discloses a reasonable price range pertaining to such virtual subject matter, yields pertaining to given prices relative to regularly fixed prices within the reasonable price range, and a yield pertaining to the aforesaid net profit based on a principal price equivalent to the buyer's maximum desired buying price after adjustment by the statistical method or multiple desired buying prices after adjustment by the statistical method together with the outline pertaining to such subject matters.

10. The real estate network market system described in claims 1 and 7, characterized by the fashion in which the Market Company selects a single seller and multiple buyers from among investors; executes each and every step of the real estate network market system for multiple virtual subject matters created by the Market Company; and discloses a reasonable price range of such virtual subject matters, yields pertaining to given prices relative to regularly fixed prices within the reasonable price range, and a yield pertaining to the aforesaid net profit value based on a principal price equivalent to the equilibrium price after adjustment by the statistical method or multiple desired buying prices after adjustment by the statistical method together with the outline pertaining to such subject matters.

11. The real estate network market system described in claim 3 and 4, characterized by the manner in which it is executed for purposes of buying and selling corporations, stocks, claims, intellectual property rights, art objects, antiques, or used articles, or for purposes of rendering services.
